(19) United States
(12) Patent Application Publication
(10) Pub. No.: US 2021/0233413 A1
(43) Pub. Date: Jul. 29, 2021

(54) REAL-TIME AUTOMATED METHOD AND SYSTEM ENABLING CONTINUOUS SUPERSONIC FLIGHT WHILE PREVENTING GROUND LEVEL SONIC BOOM

(71) Applicant: Aerion Intellectual Property Management Corporation, Palo Alto, CA (US)

(72) Inventors: Harold Eugene Holloway, Reno, NV (US); Jason Rahe Matisheck, Golden, CO (US); Laurens Jozef A Voet, Somerville, MA (US); German Andres Garzon, Reno, NV (US); Andrew Joseph Hellen, Reno, NV (US); Jukka Matti Hirvonen, Sparks, NV (US); Andrew Donald Meeker, Newbury Park, CA (US)

(73) Assignee: Aerion Intellectual Property Management Corporation, Palo Alto, CA (US)

(21) Appl. No.: 16/750,844

(22) Filed: Jan. 23, 2020

(51) Int. Cl. G08G 5/00

(52) U.S. Cl. CPC G08G 5/0039; G05D 1/106; G08G 5/0034

(57) ABSTRACT

A method for determining a Mach cutoff flight profile for an aircraft comprises receiving a flight origination and destination; receiving an initial atmospheric profile forecast; receiving user preferences on flight parameters to be optimized; computing a user cost function; determining a flight profile which implements Mach cutoff; receiving updates on the atmospheric profile forecast; determining potential sonic boom incidents; determining one or more sonic boom avoidance modifications to the flight profile that will avoid sonic boom incidents and not exceed the user cost function if potential sonic boom incidents are determined; presenting one or more sonic boom avoidance modifications to a pilot of the aircraft if potential sonic boom incidents are determined; receiving selection of one of the sonic boom avoidance modifications if potential sonic boom incidents are determined; and updating the flight profile with the selected sonic boom avoidance modification if potential sonic boom incidents are determined.

### FIELD OF THE INVENTION

Embodiments of the current invention relate to systems and methods for determining and implementing an aircraft flight profile at supersonic speeds that prevent the aircraft's sonic boom from reaching ground level.

### DESCRIPTION OF THE RELATED ART

The movement of an object through the air creates a sequence of pressure waves as moves through the air. A pressure wave moves through the air at the speed of sound. A Mach number (M) is a ratio of the speed of an object in motion through a continuum relative to the local speed of sound—i.e., v_{aircraft}/v_{sound}, wherein “v” is velocity. Referring to FIG. 1, when an aircraft is traveling at less than the speed of sound (M<1), the pressure waves are separate from one another. But, when the aircraft is traveling at speeds equal to or exceeding the speed of sound (M>1) (i.e., supersonic), the propagation of the pressure waves cannot move ahead of the moving object and start trailing it. As a result, the pressure waves compress to form a single cone-shaped wave front. Complex forms such as an aircraft generate a train of shockwaves of different intensities as it flies above the speed of sound. These waves move at different speeds and over distance coalesce into a unified leading and trailing wave front that has an overpressure and underpressure. This coalesced wave front is what an observer on the ground perceives as a sonic boom. While aircraft travel at speeds greater than the speed of sound is desirable to reduce travel times, the sonic boom that occurs at ground level is not desirable. Accordingly, non-military supersonic aircraft traveling over land during which the sonic boom reaches the surface have been banned worldwide.

However, under certain conditions, it may be possible for an aircraft to travel at speeds greater than the speed of sound without the sonic boom reaching the surface. The direction in which sound rays, or wave fronts emanating from the aircraft, propagate through the atmosphere after being initiated is governed by gradients in speed of sound and wind velocities. A caustic layer occurs at the altitude at which the sound rays become horizontal and bend upwards away from the ground. If the sound rays do not bend upwards before reaching the surface, then a sonic boom carpet is formed. Threshold Mach number (M_{Threshold}) is defined as the Mach number at which the caustic layer is coincident with the ground level. Referring to FIG. 2, when an aircraft is flying at a Mach number between 1 and the threshold (1<M<M_{Threshold}), the caustic is above ground level. When the aircraft is flying at a Mach number equal to or greater than the threshold (M≥M_{Threshold}), a sonic boom carpet is formed because the sound rays reach the ground. Mach cutoff (M_{co}) is a selectable Mach number less than M_{Threshold} at which the aircraft is flying at a speed greater than the speed of sound (1<M_{co}<M_{Threshold}), but the caustic is above the ground level so that the sonic boom does not reach the ground.

### SUMMARY OF THE INVENTION

Embodiments of the current invention provide a method for determining and implementing a Mach cutoff flight profile for an aircraft. The method broadly comprises the steps of receiving a flight origination and a flight destination; receiving an initial atmospheric profile forecast; receiving user preferences on flight parameters to be optimized; computing a user cost function; determining a flight profile which implements Mach cutoff; engaging an autopilot to implement the flight profile; receiving updates on the atmospheric profile forecast; determining potential sonic boom incidents on a periodic basis; determining one or more sonic boom avoidance modifications to the flight profile that will avoid sonic boom incidents and not exceed the user cost function if potential sonic boom incidents are determined; presenting one or more sonic boom avoidance modifications to the flight profile to a pilot of the aircraft if potential sonic boom incidents are determined; receiving selection of one of the sonic boom avoidance modifications to the flight profile if potential sonic boom incidents are determined; and updating the flight profile with the selected sonic boom avoidance modification if potential sonic boom incidents are determined.

Another embodiment of the current invention provides a method for determining a Mach cutoff flight profile for an aircraft. The method broadly comprises the steps of receiving a flight origination and a flight destination; receiving an initial atmospheric profile forecast; receiving terrain data; receiving information governing restricted operations; receiving user preferences on flight parameters to be optimized; computing a user cost function; determining a flight profile which implements Mach cutoff; engaging an autopilot to implement the flight profile; receiving updates on the atmospheric profile forecast; determining potential sonic boom incidents on a periodic basis; determining one or more optimized modifications to the flight profile to lower the user cost function if no potential sonic boom incidents are determined; presenting one or more optimized modifications to the flight profile to the pilot if no potential sonic boom incidents are determined; receiving selection of one of the optimized modifications to the flight profile if no potential sonic boom incidents are determined; and updating the flight profile with the optimized modification if no potential sonic boom incidents are determined.

Yet another embodiment of the current invention provides a system for determining a Mach cutoff flight profile for an aircraft. The system broadly comprises a display, a user interface, an aircraft system, and a processing element. The display is configured to present information about a flight profile. The user interface is configured to receive input from a pilot and/or co-pilot. The aircraft system is configured to control the operation of aircraft mechanical systems and subsystems. The processing element is configured or programmed to receive a flight origination and a flight destination, receive an initial atmospheric profile forecast, receive user preferences on flight parameters to be optimized, compute a user cost function, determine a flight profile which implements Mach cutoff, communicate the flight profile to the aircraft system to engage an autopilot, receive updates on the atmospheric profile forecast, determine potential sonic boom incidents on a periodic basis, determine one or more sonic boom avoidance modifications to the flight profile that will avoid sonic boom incidents and not exceed the user cost function if potential sonic boom incidents are determined, present one or more sonic boom avoidance modifications to the flight profile to a pilot of the aircraft if potential sonic boom incidents are determined, receive selection of one of the sonic boom avoidance modifications to the flight profile if potential sonic boom incidents are determined, and update the flight profile with the selected sonic boom avoidance modification if potential sonic boom incidents are determined.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is an environmental illustration of a first aircraft flying at less than the speed of sound (M<1) and a second aircraft flying at greater than the speed of sound (M>1);

FIG. 2 is an environmental illustration of a first aircraft flying at Mach cutoff so that a sonic boom remains at a level above a caustic level and a second aircraft flying at a speed greater than Mach cutoff so that a sonic boom carpet is formed at ground level;

FIG. 3 is a schematic block diagram of various components of a system, constructed in accordance with various embodiments of the current invention, for determining a Mach cutoff flight profile for an aircraft;

FIG. 4 is a block flow diagram depicting the operation of various components of the system of FIG. 3;

FIG. 5 is an environmental illustration of an aircraft employing a first sonic boom avoidance technique which implements flying the aircraft on a different route or at a different altitude;

FIG. 6 is an environmental illustration of an aircraft employing a second sonic boom avoidance technique which implements flying the aircraft at a different Mach number speed;

FIG. 7A is a listing of a first portion of the steps of a method for determining a Mach cutoff flight profile for an aircraft; and

FIG. 7B is a listing of a second portion of the steps of the method for determining a Mach cutoff flight profile for an aircraft.

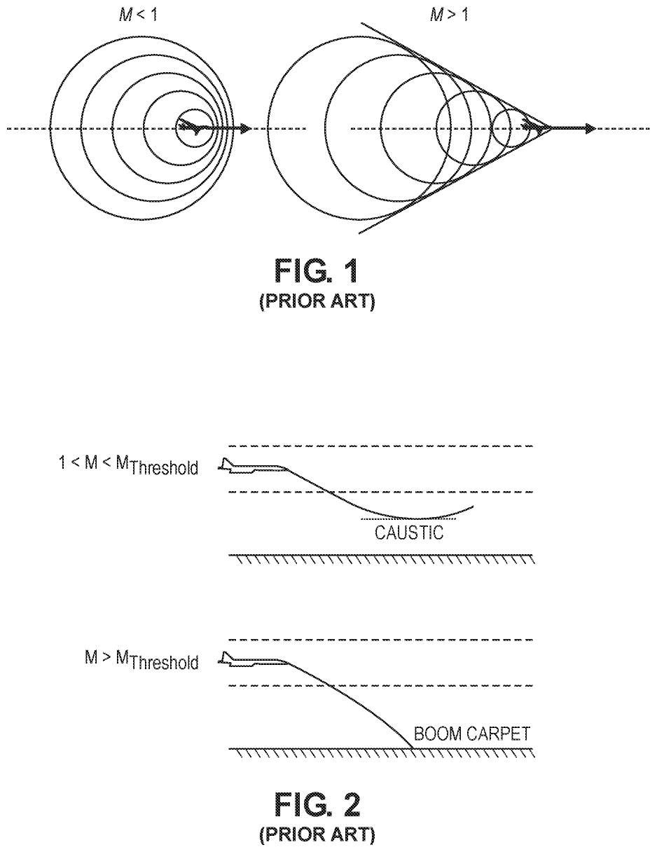

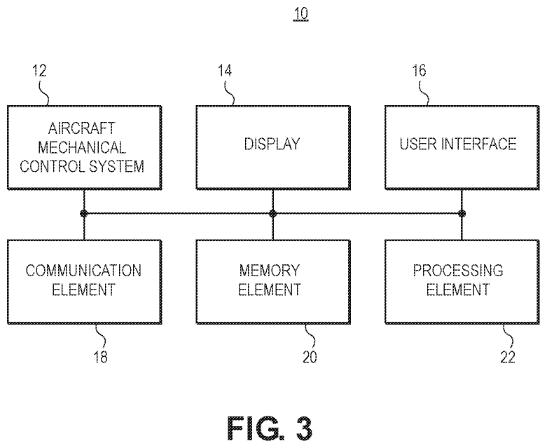

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

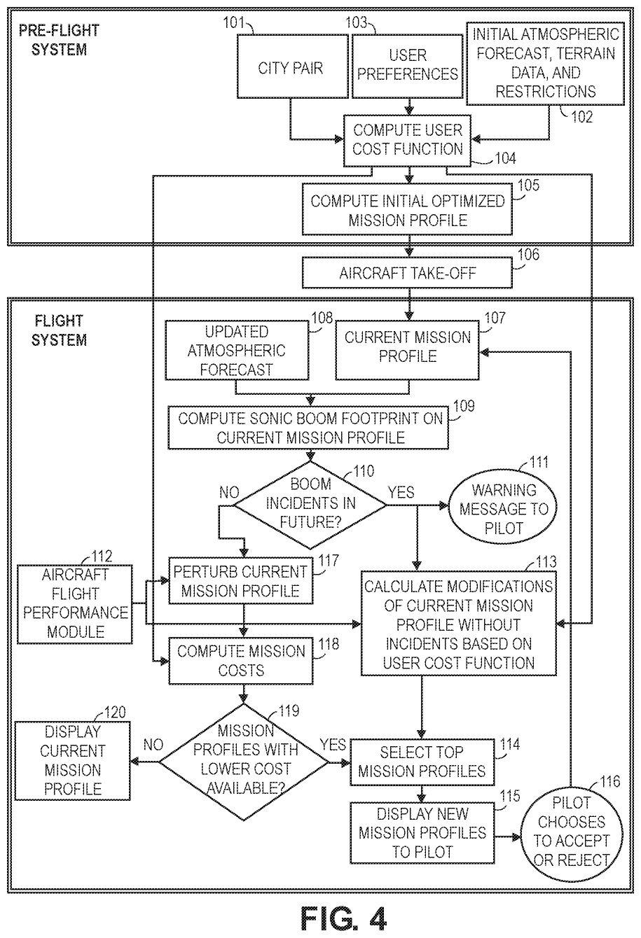

A system 10, constructed in accordance with various embodiments of the current invention, for determining a Mach cutoff flight profile for an aircraft is shown in FIG. 3. The system 10 broadly comprises an aircraft system 12, a display 14, a user interface 16, a communication element 18, a memory element 20, and a processing element 22. The Mach cutoff flight profile is typically reviewed, and possibly modified, by a pilot of the aircraft. In some embodiments, the system 10 may be utilized with other vehicles, such as unmanned aerial vehicles, or weapons, such as a cruise missile or a rocket, that travel through the atmosphere. In such embodiments, the Mach cutoff flight profile may be reviewed, and possibly modified, by an operator of the vehicle or weapon.

The aircraft system 12 generally provides control of the electro-mechanical systems and subsystems of the aircraft, such as thrust components, control surface components, and navigation components. The aircraft system 12 may include electronic and/or electrical circuits, with analog control circuits, digital control circuits, signal processing circuits, or the like, or combinations thereof, which provide open loop or feedback control of the mechanical systems and subsystems. Furthermore, the aircraft system 12 may include an autopilot which automatically operates the electro-mechanical systems and subsystems. The autopilot is operable to implement the Mach cutoff flight profile.

The display 14 presents information to a user that is input to the system 10 and/or output from the system 10. The display 14 may include video devices of the following types: plasma, light-emitting diode (LED), organic LED (OLED), Light Emitting Polymer (LEP) or Polymer LED (PLED), liquid crystal display (LCD), thin film transistor (TFT) LCD, LED side-lit or back-lit LCD, heads-up displays (HUDs), or the like, or combinations thereof. The display 14 may include a screen on which the information is presented, with the screen possessing any one of a variety of shapes, such as a square or a rectangular aspect ratio that may be viewed in either a landscape or a portrait mode. In various embodiments, the display 14 may also include a touch screen occupying the entire screen or a portion thereof so that the display 14 functions as part of the user interface 16. The touch screen may allow the user to interact with the system 10 by physically touching, swiping, or gesturing on areas of the screen. The display 14 may be in electronic communication with the memory element 20 and the processing element 22 and may receive data or information therefrom that is to be shown on the display 14.

The user interface 16 generally allows the user to utilize inputs and outputs to interact with the system 10. Inputs may include buttons, pushbuttons, knobs, jog dials, shuttle dials, directional pads, multidirectional buttons, switches, keypads, keyboards, mice, joysticks, microphones, or the like, or combinations thereof. Outputs may include audio speakers, lights, dials, meters, printers, or the like, or combinations thereof. With the user interface 16, the user may be able to control the features and operation of the display 14, as well as the functions of the system 10. For example, the user may be able to zoom in and out on the display 14 using either virtual onscreen buttons or actual pushbuttons. In addition, the user may be able to pan the image on the display 14 either by touching and swiping the screen of the display 14 or by using multidirectional buttons or dials.

The communication element 18 generally allows the system 10 to communicate with other systems, computing devices, satellites, networks, and the like. The communication element 18 may include signal and/or data transmitting and receiving circuits, such as antennas, amplifiers, filters, mixers, oscillators, digital signal processors (DSPs), and the like. The communication element 18 may establish communication wirelessly by utilizing radio frequency (RF) signals and/or data that comply with satellite technologies or communication standards such as cellular 2G, 3G, 4G, Voice over Internet Protocol (VoIP), LTE, Voice over LTE (VoLTE), or 5G, Institute of Electrical and Electronics Engineers (IEEE) 802.11 standard such as WiFi, IEEE 802.16 standard such as WiMAX, Bluetooth™, or combinations thereof. In addition, the communication element 18 may utilize communication standards such as ANT, ANT+, Bluetooth™ low energy (BLE), the industrial, scientific, and medical (ISM) band at 2.4 gigahertz (GHz), or the like. Alternatively, or in addition, the communication element 18 may establish communication through connectors or couplers that receive metal conductor wires or cables which are compatible with networking technologies such as ethernet. In certain embodiments, the communication element 18 may also couple with optical fiber cables. The communication element 18 may be in electronic communication with the memory element 20 and the processing element 22.

The memory element 20 may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element 20 may be embedded in, or packaged in the same package as, the processing element 22. The memory element 20 may include, or may constitute, a non-transitory “computer-readable medium”. The memory element 20 may store the instructions, code, code statements, code segments, software, firmware, programs, applications, apps, services, daemons, or the like that are executed by the processing element 22. The memory element 20 may also store data that is received by the processing element 22 or the device in which the processing element 22 is implemented. The processing element 22 may further store data or intermediate results generated during processing, calculations, and/or computations as well as data or final results after processing, calculations, and/or computations. In addition, the memory element 20 may store settings, data, documents, sound files, photographs, movies, images, databases, and the like.

The processing element 22 may comprise one or more processors. The processing element 22 may include electronic hardware components such as microprocessors (single-core or multi-core), microcontrollers, digital signal processors (DSPs), field-programmable gate arrays (FPGAs), analog and/or digital application-specific integrated circuits (ASICs), or the like, or combinations thereof. The processing element 22 may generally execute, process, or run instructions, code, code segments, code statements, software, firmware, programs, applications, apps, processes, services, daemons, or the like. The processing element 22 may also include hardware components such as registers, finite-state machines, sequential and combinational logic, and other electronic circuits that can perform the functions necessary for the operation of the current invention. In certain embodiments, the processing element 22 may include multiple computational components and functional blocks that are packaged separately but function as a single unit. The processing element 22 may be in electronic communication with the other electronic components through serial or parallel links that include universal busses, address busses, data busses, control lines, and the like. In some embodiments, all of the components of the processing element 22 are located on board the aircraft. In other embodiments, at least a portion of the components of the processing element 22 may be located outside of the aircraft with communication between the components being implemented via the communication element 18 using wireless communication protocols.

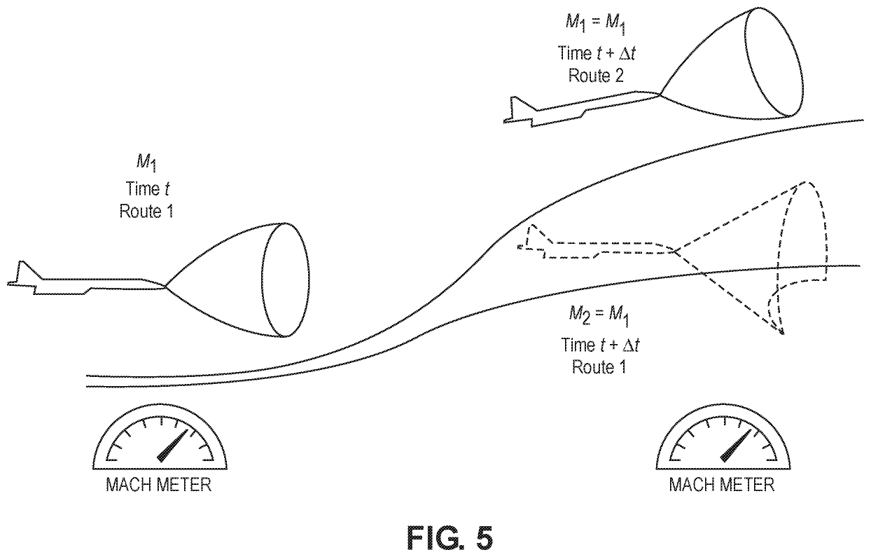

The processing element 22 may be operable, configured, or programmed to perform the following functions by utilizing hardware, software, firmware, or combinations thereof. The processing element 22 may also act or perform in combination with the display 14, the user interface 16, the communication element 18, and the memory element 20 to perform the following functions with reference to the diagram of FIG. 4. Referring to block 101, the processing element 22 receives input from the user (through the user interface 16), such as a pilot, about an upcoming flight before the flight takes place. The input may include an origin location of the flight and a destination location of the flight. The processing element 22 may determine an initial route between the origination and the destination locations. Referring to block 102, the processing element 22 also receives input from a weather prediction service which provides a forecast of atmospheric profiles (e.g., temperature, wind speed/direction, humidity, severe weather, etc.) along the route. The processing element 22 also receives data regarding the terrain over which the aircraft is going to fly. The data may include the elevation above sea level for the land in the path of the flight. Of particular interest may be any hills or mountain ranges. The processing element 22 also receives information regarding regions or airspaces in which the airspeed is restricted to a certain limit. Referring to block 103, the processing element 22 also receives user preferences from the pilot as to which parameter or combination of parameters he wishes to optimize. For example, he may wish to minimize the time duration of the flight. Or, he may wish to minimize fuel consumption. Referring to block 104, based on the parameter or combination of parameters to optimize, the processing element 22 may compute, calculate, or determine a user cost function. Referring to block 105, the processing element 22 also computes, calculates, or determines a flight profile which includes a route that the aircraft will follow, a Mach or speed profile, and an altitude profile. The Mach profile may include an aircraft speed for each point, or set of points, along the route such that the aircraft is flying at Mach cutoff for the maximum amount of time or maximum percentage of the route. The altitude profile may include an altitude, or height above ground, of the aircraft for each point, or set of points, along the route. The processing element 22 communicates the flight profile information to the aircraft system 12 which sets the parameters for the mechanical systems and subsystems as well as the autopilot to operate the aircraft. Referring to block 106, the aircraft takes off.

Referring to block 107, the aircraft flies the route while maintaining the current flight profile. Referring to block 108, the processing element receives updated atmospheric profile forecasts on a periodic basis. Referring to blocks 109 and 110, the processing element 22 computes, calculates, or determines potential sonic boom incidents that may occur at some point during the flight based on the flight profile and considering changes to the atmospheric profiles. Referring to block 111, if potential sonic boom incidents are determined, then a warning message advising the pilot of the impending condition change is shown to the pilot on the display 14.

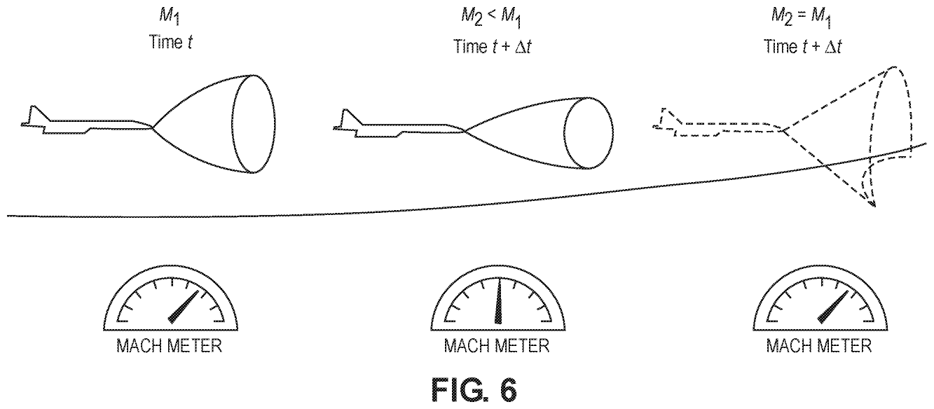

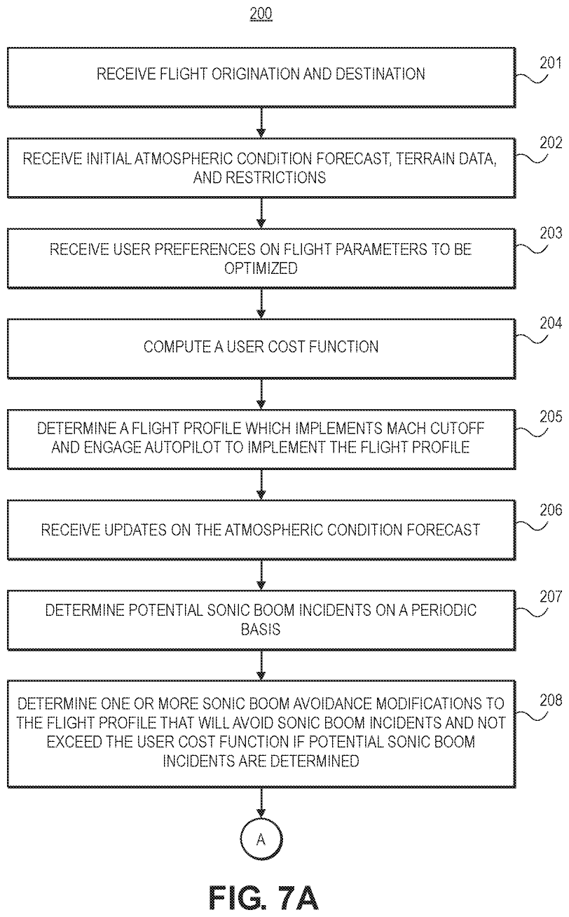

Referring to block 112, the processing element 22 may execute code or software, or be in communication with a computing device which executes code or software, that includes an aircraft flight performance module used to simulate the aircraft's behavior with respect to changes (or perturbations) in various independent variables affecting the aircraft's flight performance. This model is used to simulate the dynamic flight path of the aircraft along its route between origin and destination. The aircraft flight performance module outputs a set of reference parameters such as Mach number, magnetic heading, and altitude that are transmitted to the aircraft's flight management system to provide reference commands for the aircraft's autopilot and the pilot's flight displays. Using the output of the aircraft flight performance module of block 112, the processing element 22 computes, calculates, or determines a plurality of avoidance modifications to the flight profile that will avoid boom incidents and not exceed the user cost function at block 113. For example, avoidance modifications to the flight profile may include altering the route of the flight to fly over a different area of land to avoid higher elevations while maintaining the same altitude and aircraft Mach number. Referring to FIG. 5, avoidance modifications to the flight profile may also include increasing the altitude of the aircraft while maintaining the same aircraft Mach number and route. Referring to FIG. 6, avoidance modifications to the flight profile may further include decreasing the aircraft Mach number while maintaining the same aircraft altitude and route. Decreasing the aircraft Mach number reduces the size of the sonic boom profile cone so that the sonic boom does not reach the ground. Referring to blocks 113, 114, and 115, one or more of the avoidance modifications are presented on the display 14 to the pilot. The processing element 22 then receives the selection of which avoidance modification to the flight profile the pilot wishes to implement. The processing element 22 updates the current flight profile with the avoidance modification and the operation of the processing element 22 returns to block 107. The updated flight profile may also be forwarded to the aircraft system 12 to be implemented by the electro-mechanical systems and subsystems including the autopilot.

Referring again to block 110, if the processing element 22 does not compute, calculate, or determine potential boom incidents that may occur based on the flight profile, then the processing element 22 may receive input from the aircraft flight performance module of block 112 and perturb the current flight profile at block 117. The perturbation may include varying aspects of the flight profile to lower the user cost function—without creating a sonic boom carpet. For example, the processing element 22 may vary the route, increase or decrease the aircraft Mach number for one or more portions of the rest of the flight, increase or decrease the aircraft altitude for one or more portions of the rest of the flight, either individually or in various combinations. Referring to blocks 118 and 119, the processing element 22 computes, calculates, or determines the cost function associated with each contemplated variation of the flight profile. Referring to block 120, if none of the variations, or perturbations, result in lowering the user cost function, then the current flight profile remains in effect and may be shown on the display 14 for the pilot thereby maintaining situational awareness. Otherwise, if any of the variations, or perturbations, result in lowering the user cost function, then the variations are optimized modifications to the flight profile. The operation of the processing element 22 returns to block 114 and some or all of the optimized modifications may be presented on the display 14 to the pilot. The processing element 22 then receives the selection of which optimized modification to the flight profile the pilot wishes to implement. The processing element 22 updates the current flight profile with the optimized modification and the operation of the processing element 22 returns to block 107. The updated flight profile may also be forwarded to the aircraft system 12 to be implemented by the electro-mechanical systems and subsystems including the autopilot.

Perturbations of the flight profile to minimize the time duration of the flight may be performed with the geolocation of the aircraft as an input to the aircraft flight performance module of block 112, or as a consideration in determining optimization. If the aircraft is flying over land, then the aircraft is prohibited from flying such that a sonic boom is created at ground level, due to the speed of the aircraft, the altitude of the aircraft, or both. If the aircraft is flying over an ocean, then the aircraft may fly such that a limited lateral width sonic boom is created at water level. The route of the flight may be optimized to avoid having the sonic boom impact adjacent areas while the aircraft is flying in unrestricted airspace. When the aircraft is flying over land, over ocean, and from one to the other, the flight profile is optimized to reduce the time duration of the flight while avoiding creation of a sonic boom carpet. The flight profile may also be recomputed, recalculated, or redetermined to compensate for extreme weather, air traffic, or unexpected occurrences. Furthermore, the processing element 22, perhaps in combination with the memory element 20, utilizes the geolocation to determine whether the aircraft is operating in a region with restricted speeds over land or water. The processing element 22 may update the current flight profile according to potential airspeed restrictions.

Due to the uncertainty or error margin of the atmospheric forecast model, the processing element 22 may compute, calculate, or determine the altitude of the aircraft for the altitude profile to be greater than it needs to be for the actual conditions. This may be realizable with the application of a selectable, differential Mach margin. This action also ensures not having any sonic boom footprint on the ground level at all times. Historical trends of the atmospheric forecast model along the predicted course are also used to improve the estimate of the altitude margin of the caustic level.

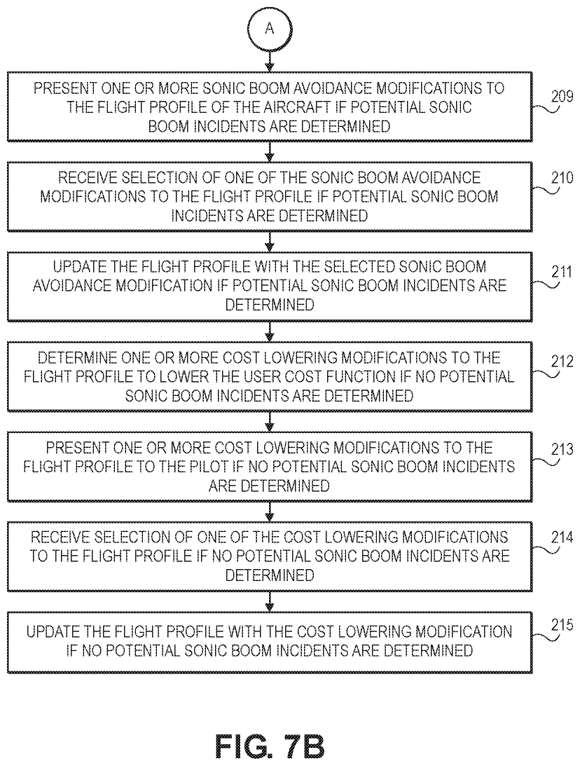

FIGS. 7A and 7B depict a listing of at least a portion of the steps of an exemplary computer-implemented method 200 for determining a Mach cutoff flight profile for an aircraft. The steps may be performed in the order shown in FIGS. 7A and 7B, or they may be performed in a different order. Furthermore, some steps may be performed concurrently as opposed to sequentially. In addition, some steps may be optional or may not be performed. The method 200 may be implemented by the processing element 22, in combination with the aircraft system 12, the display 14, the user interface 16, the communication element 18, and the memory element 20, as well as possibly other computing devices in communication with the processing element 22.

Referring to step 201, a flight origin location and a flight destination location are received from the user about an upcoming flight before the flight takes place.

Referring to step 202, an initial atmospheric condition forecast is received. The forecast may include temperature, wind speed/direction, humidity, and severe weather predictions and may be received from a weather prediction service. Data is also received regarding the terrain over which the aircraft is going to fly. The data may include the elevation above sea level for the land in the path of the flight. Of particular interest may be any hills or mountain ranges. In addition, information is received regarding regions or airspaces in which the airspeed is restricted to a certain limit.

Referring to step 203, user preferences for flight parameters to be optimized are received. The aircraft pilot and/or co-pilot enter the flight parameter or combination of parameters to be optimized. For example, they may wish to minimize the time duration of the flight. Or, they may wish to minimize fuel consumption.

Referring to step 204, a user cost function is computed, calculated, or determined. The cost function varies according to the flight parameters to be optimized.

Referring to step 205, a flight profile which implements Mach cutoff is computed, calculated, or determined. The flight profile includes a route that the aircraft will follow, a Mach or aircraft speed profile, an altitude profile, and information governing aircraft operations such as data identifying areas with restricted altitudes and airspeeds. The Mach profile may include an aircraft speed for each point, or set of points, along the route such that the aircraft is flying at Mach cutoff for the maximum amount of time or maximum percentage of the route. The altitude profile may include an altitude, or height above ground, of the aircraft for each point, or set of points, along the route. The autopilot of the aircraft system 12 is then engaged to implement the flight profile.

Referring to step 206, updates on the atmospheric profile forecast are received. The updates may be received from the weather prediction service on a periodic basis.

Referring to step 207, potential sonic boom incidents that may occur at some point during the flight are computed, calculated, or determined on a periodic basis. The potential sonic boom incidents are determined based on the flight profile and considering changes to the atmospheric profiles.

Referring to step 208, one or more sonic boom avoidance modifications to the flight profile that will avoid sonic boom incidents are computed, calculated, or determined if potential sonic boom incidents are determined. The sonic boom avoidance modifications to the flight profile are not to exceed the user cost function. Sonic boom avoidance modifications to the flight profile may include altering the route of the flight to fly over a different area of land to avoid higher elevations while maintaining the same altitude and aircraft Mach number. Referring to FIG. 5, sonic boom avoidance modifications to the flight profile may also include increasing the altitude of the aircraft while maintaining the same aircraft Mach number and route. Increasing the altitude of the aircraft raises the sonic boom profile cone so that the caustic is above the ground and a sonic boom carpet is not formed. Referring to FIG. 6, sonic boom avoidance modifications to the flight profile may further include decreasing the aircraft Mach number while maintaining the same altitude of the aircraft and route. Decreasing the aircraft Mach number reduces the size of the sonic boom profile cone so that the sonic boom does not reach the ground.

Referring to step 209, the sonic boom avoidance modifications to the flight profile that will avoid sonic boom incidents are presented to the aircraft pilot and/or co-pilot on the display 14 if potential sonic boom incidents have been determined.

Referring to step 210, the selection of one of the sonic boom avoidance modifications to the flight profile that will avoid sonic boom incidents is received if potential sonic boom incidents have been determined. The selection is received from the aircraft pilot and/or co-pilot.

Referring to step 211, the flight profile is updated with the selected sonic boom avoidance modification if potential sonic boom incidents are determined. The flight profile may be updated with a change to the route or heading, a change to the aircraft Mach number, the altitude of the aircraft, or combinations thereof.

Referring to step 212, one or more optimized modifications to the flight profile to lower the user cost function are computed, calculated, or determined if no potential sonic boom incidents are determined. The determination may include perturbations or changes to any aspect of the flight profile—without creating a sonic boom carpet. For example, the route may be varied, the Mach number aircraft speed for one or more portions of the rest of the flight may be increased or decreased, the aircraft altitude for one or more portions of the rest of the flight may be increased or decreased, either individually or in various combinations.

Referring to step 213, the optimized modifications to the flight profile are presented to the aircraft pilot on the display 14 if no potential sonic boom incidents have been determined.

Referring to step 214, the selection of one of the optimized modifications to the flight profile that will avoid sonic boom incidents is received if no potential sonic boom incidents have been determined. The selection is received from the aircraft pilot.

Referring to step 215, the flight profile is updated with the selected optimized modification if no potential sonic boom incidents are determined. The flight profile may be updated with a change to the route or heading, a change to the aircraft Mach number, the altitude of the aircraft, or combinations thereof.

Many of the steps of the method 200 may be repeated indefinitely throughout the duration of the flight. For example, the potential for a sonic boom incident to occur may be repeatedly evaluated. And based on the likelihood of a sonic boom incident, changes to the flight profile may be suggested and then enacted, if selected.

### Additional Considerations

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A method for determining a Mach cutoff flight profile for an aircraft, the method comprising:
receiving data representative of a flight origination and a flight destination;
receiving an initial atmospheric profile forecast;
receiving user preferences on flight parameters to be optimized;
computing a user cost function;
determining a flight profile which implements Mach cutoff;
engaging an autopilot to implement the flight profile;
receiving updates on the atmospheric profile forecast;
determining potential sonic boom incidents on a periodic basis;
determining one or more sonic boom avoidance modifications to the flight profile that will avoid sonic boom incidents and not exceed the user cost function if potential sonic boom incidents are determined;
presenting one or more sonic boom avoidance modifications to the flight profile to a pilot of the aircraft if potential sonic boom incidents are determined;
receiving selection of one of the sonic boom avoidance modifications to the flight profile if potential sonic boom incidents are determined; and
updating the flight profile with the selected sonic boom avoidance modification if potential sonic boom incidents are determined.

2. The method of claim 1, further comprising
determining one or more optimized modifications to the flight profile to lower the user cost function if no potential sonic boom incidents are determined;
presenting one or more optimized modifications to the flight profile to the pilot if no potential sonic boom incidents are determined;
receiving selection of one of the optimized modifications to the flight profile if no potential sonic boom incidents are determined; and
updating the flight profile with the optimized modification if no potential sonic boom incidents are determined.

3. The method of claim 2, wherein the flight profile includes an aircraft speed profile, an aircraft altitude profile, and an aircraft route and the optimized modifications to the flight profile include modifications to the aircraft speed profile, the aircraft altitude profile, the aircraft route, or combinations thereof.

4. The method of claim 1, further comprising receiving terrain data and receiving information governing restricted operations.

5. The method of claim 1, wherein the flight profile includes an aircraft speed profile, an aircraft altitude profile, and an aircraft route.

6. The method of claim 5, wherein the aircraft speed profile includes a value of a speed of the aircraft which varies according to a location of the aircraft along the aircraft route, and the aircraft altitude profile includes a value of an altitude of the aircraft which varies according to a location of the aircraft along the aircraft route.

7. The method of claim 5, wherein the sonic boom avoidance modifications to the flight profile include modifications to the aircraft speed profile, the aircraft altitude profile, the aircraft route, or combinations thereof.

8. A method for determining a Mach cutoff flight profile for an aircraft, the method comprising:
receiving data representative of a flight origination and a flight destination;
receiving an initial atmospheric profile forecast;
receiving terrain data;
receiving information governing restricted operations;
receiving user preferences on flight parameters to be optimized;
computing a user cost function;
determining a flight profile which implements Mach cutoff;
engaging an autopilot to implement the flight profile;
receiving updates on the atmospheric profile forecast;
determining potential sonic boom incidents on a periodic basis;
determining one or more optimized modifications to the flight profile to lower the user cost function if no potential sonic boom incidents are determined;
presenting one or more optimized modifications to the flight profile to the pilot if no potential sonic boom incidents are determined;
receiving selection of one of the optimized modifications to the flight profile if no potential sonic boom incidents are determined; and
updating the flight profile with the optimized modification if no potential sonic boom incidents are determined.

9. The method of claim 8, wherein the flight profile includes an aircraft speed profile, an aircraft altitude profile, and an aircraft route.

10. The method of claim 9, wherein the aircraft speed profile includes a value of a speed of the aircraft which varies according to a location of the aircraft along the aircraft route.

11. The method of claim 9, wherein the aircraft altitude profile includes a value of an altitude of the aircraft which varies according to a location of the aircraft along the aircraft route.

12. The method of claim 9, wherein the optimized modifications to the flight profile include modifications to the aircraft speed profile, the aircraft altitude profile, the aircraft route, or combinations thereof.

13. The method of claim 12, further comprising:
determining one or more sonic boom avoidance modifications to the flight profile that will avoid sonic boom incidents and not exceed the user cost function if potential sonic boom incidents are determined;
presenting one or more sonic boom avoidance modifications to the flight profile to a pilot of the aircraft if potential sonic boom incidents are determined;
receiving selection of one of the sonic boom avoidance modifications to the flight profile if potential sonic boom incidents are determined; and
updating the flight profile with the selected sonic boom avoidance modification if potential sonic boom incidents are determined,
wherein the sonic boom avoidance modifications to the flight profile include modifications to the aircraft speed profile, the aircraft altitude profile, the aircraft route, or combinations thereof.

14. A system for determining a Mach cutoff flight profile for an aircraft, the system comprising:
a display configured to present information about a flight profile;
a user interface configured to receive input from a pilot and/or co-pilot;
an aircraft system configured to control the operation of aircraft mechanical systems and subsystems and to operate an autopilot; and
a processing element configured or programmed to:
receive data representative of a flight origination and a flight destination,
receive an initial atmospheric profile forecast,
receive user preferences on flight parameters to be optimized,
compute a user cost function,
determine a flight profile which implements Mach cutoff,
communicate the flight profile to the aircraft system to engage an autopilot,
receive updates on the atmospheric profile forecast,
determine potential sonic boom incidents on a periodic basis,
determine one or more sonic boom avoidance modifications to the flight profile that will avoid sonic boom incidents and not exceed the user cost function if potential sonic boom incidents are determined,
present one or more sonic boom avoidance modifications to the flight profile to a pilot of the aircraft if potential sonic boom incidents are determined,
receive selection of one of the sonic boom avoidance modifications to the flight profile if potential sonic boom incidents are determined, and
update the flight profile with the selected sonic boom avoidance modification if potential sonic boom incidents are determined.

15. The system of claim 14, wherein the processing element is further configured or programmed to:
determine one or more optimized modifications to the flight profile to lower the user cost function if no potential sonic boom incidents are determined,
present one or more optimized modifications to the flight profile to the pilot if no potential sonic boom incidents are determined,
receive selection of one of the optimized modifications to the flight profile if no potential sonic boom incidents are determined, and
update the flight profile with the optimized modification if no potential sonic boom incidents are determined.

16. The system of claim 15, wherein the flight profile includes an aircraft speed profile, an aircraft altitude profile, and an aircraft route and the optimized modifications to the flight profile include modifications to the aircraft speed profile, the aircraft altitude profile, the aircraft route, or combinations thereof.

17. The system of claim 14, wherein the processing element is further configured or programmed to receive terrain data and receive information governing restricted operations.

18. The system of claim 14, wherein the flight profile includes an aircraft speed profile, an aircraft altitude profile, and an aircraft route.

19. The system of claim 18, wherein the aircraft speed profile includes a value of a speed of the aircraft which varies according to a location of the aircraft along the aircraft route, and the aircraft altitude profile includes a value of an altitude of the aircraft which varies according to a location of the aircraft along the aircraft route.

20. The system of claim 18, wherein the sonic boom avoidance modifications to the flight profile include modifications to the aircraft speed profile, the aircraft altitude profile, the aircraft route, or combinations thereof.
